(19) United States
(12) Patent Application Publication
(10) Pub. No.: US 2026/0331394 A1
(43) Pub. Date: Oct. 22, 2026

(54) CIRCUIT BREAKER AND METHOD

(71) Applicant: Siemens Aktiengesellschaft, München (DE)

(72) Inventor: Marvin Tannhäuser, Hausen (DE)

(21) Appl. No.: 19/107,725

(22) PCT Filed: Aug. 23, 2023
(86) PCT No.: PCT/EP2023/073117

§ 371 Date: Feb. 28, 2025

(30) Foreign Application Priority Data
Aug. 31, 2022 (DE) 10 2022 209 018.7

(51) Int. Cl. H01H 9/54; H02H 3/08

(52) U.S. Cl. CPC H01H 9/548; H02H 3/08

(57) ABSTRACT

A circuit breaker protecting low-voltage circuits includes connections for circuit conductors, a mechanical break contact unit having closed contacts for current flux or open contacts for galvanic interruption in the circuit preventing current flux. An electronic interruption unit is connected to the break contact unit and semiconductor-based switch elements cause high-ohmic state of switch elements preventing current flux or low-ohmic state for current flux in the circuit. A differential current level of the conductors is ascertained, and upon overshooting first differential current limiting values or first differential current time limiting values, current flux in the circuit is prevented by switch elements of the interruption unit being in high-ohmic state and closed break contacts. Once preventing current flux by the high-ohmic state of the switch elements and closed contacts, overshooting of second differential current limiting values or second differential current time limiting values is checked.

The invention relates to the technical field of a circuit-breaker for a low-voltage circuit having an electronic interruption unit, according to the introductory clause of patent claim 1, and to a method for a circuit-breaker for a low-voltage circuit having an electronic interruption unit.

term “low voltage” signifies voltages of up to 1,000 volts AC or up to 1, 500 volts DC. In particular, the term “low voltage” signifies voltages which are greater than the extra-low voltage, having values of 50 volts AC or 120 volts DC.

The terms “low-voltage circuit” or “low-voltage network” or “low-voltage installation” signify circuits having nominal currents or rated currents of up to 125 amperes, specifically of up to 63 amperes. In particular, the term “low-voltage circuit” signifies circuits having nominal currents or rated currents of up to 50 amperes, 40 amperes, 32 amperes, amperes, 16 amperes or 10 amperes. In particular, the above-mentioned current values signify nominal, rated, and/or cut-off currents, i.e. the maximum current which, under normal circumstances, is conducted via the circuit, or with effect from which the electric circuit is customarily interrupted, for example by means of a protective device, such as a circuit-breaker, a line circuit-breaker or a power circuit-breaker. Nominal currents can be further staggered, from 0.5 A through 1 A, 2 A, 3 A, 4 A, 5 A, 6 A, 7 A, 8 A, 9 A, 10 A, etc., up to 16 A.

Line circuit-breakers are well-known overcurrent protection devices, which are employed in electrical installation engineering in low-voltage circuits. Line circuit-breakers protect lines against damage resulting from a heat-up associated with an excessively high current and/or a short-circuit. A line circuit-breaker can automatically interrupt the circuit in the event of an overload and/or a short-circuit. A line circuit-breaker is a protective element with no automatic reset.

Powers circuit-breakers, conversely to line circuit-breakers, are designed for currents in excess of 125 A and, in some cases, even for currents of 63 A or higher. Consequently, line circuit-breakers assume a simpler and more delicate design. Line circuit-breakers customarily comprise a fastening facility for fastening to a “top hat rail”(mounting rail, DIN rail, or TH35).

Line circuit-breakers according to the prior art are of an electromechanical design. In a housing, they comprise a mechanical switching contact or open-circuit shunt release for the interruption (tripping) of electric current. Customarily, a bimetallic protective element or bimetallic element is employed for tripping (interruption) in the event of a prolonged overcurrent (overcurrent protection) or in the event of a thermal overload (overload protection). An electromagnetic trip element having a coil is employed for short-term tripping in the event of an overshoot of an overcurrent limiting value, or in the event of a short-circuit (short-circuit protection). One or more arc-quenching chamber(s) or arc-quenching devices are provided. Connecting elements for conductors of the electric circuit which is to be protected are also provided. Fault current circuit-breakers for electric circuits, in particular for low-voltage circuits or installations, are generally known. Fault current circuit-breakers are also described as residual-current devices, or RCDs for short.

Fault current circuit-breakers ascertain the summated current in an electric circuit which, under normal circumstances, is equal to zero, and interrupt the electric circuit in the event of an overshoot of a differential current value, i.e. a summated current which is not equal to zero, and which exceeds a specific (differential) current value or fault current value.

Almost all existing fault current circuit-breakers comprise a summation current transformer, the primary winding of which is formed by the conductors of the circuit, and the secondary winding of which outputs the summated current which, directly or indirectly, is employed for interrupting the electric circuit.

To this end, two or more conductors, generally the supply and return conductors or the phase and neutral conductors in a single-phase AC network, all three phase conductors, or all three phase conductors and the neutral conductor in a three-phase AC network, are led through a generally annular core of a ferromagnetic material. Only the differential current on the conductors, i.e. a current which deviates from the supply and return current, is transformed. Customarily, the summated current in an electric circuit is equal to zero. Fault currents can be detected accordingly.

A flow of current to ground, for example, on the energy sink side or load side, is described in this context as a fault current. A fault is present, for example, in the event that an electrical connection exists between a phase conductor of the electric circuit and ground. This occurs, for example, if a person touches the phase conductor. In this case, a proportion of electric current does not flow back, as is customary, via the neutral conductor or PEN conductor, but flows through the person and ground. This fault current can be detected by means of the summation current transformer, as the quantitative sum of the inflow and the return flow of current thus captured is not equal to zero. By means of a relay or a retention magnet trip element, for example having an associated mechanism, an interruption of the circuit, e.g. of at least one, of a proportion, or of all conductors is executed. Fault current circuit-breakers for the detection of AC fault currents are generally known from printed publication DE 44 32 643A1 .

The primary function of fault current circuit-breakers is the protection of persons against electric currents (electric shock), and the protection of installations, machines or buildings against fire caused by electrical insulation faults.

If the fault current circuit-breaker, or the summation current transformer thereof, is configured such that the secondary side energy of the summation current transformer is sufficient for actuating a trip unit, an interruption unit or a trip element, a fault current circuit-breaker of this type is described as system voltage-independent.

If auxiliary energy is required or employed for the trip circuit, which auxiliary energy, in general, is generated by a power supply unit which is provided in the fault current circuit-breaker, a fault current circuit-breaker of this type is described as a system voltage-dependent fault current circuit-breaker. This means that system voltage-dependent fault current circuit-breakers contain a power supply unit for the supply of energy for a fault current detection function (and are thus not system voltage-independent). These power supply units are necessary, for example, for the detection of fault currents in DC voltage networks and in combined DC/AC networks, or in high-frequency circuits.

Circuit-breakers having an electronic interruption unit represent a relatively novel development. These circuit-breakers comprise a semiconductor-based electronic interruption unit. This means that the electric current flux is routed via semiconductor components or semiconductor switches, which can be switched for the interruption of the electric current flux, or for the conduction thereof. In many cases, circuit-breakers having an electronic interruption unit further comprise a mechanical break contact system, in particular having breaking properties in accordance with applicable standards for low-voltage circuits, wherein the contacts of the mechanical break contact system are connected in series with the electronic interruption unit, i.e. the current of the low-voltage circuit which is to be protected is routed via both the mechanical contact system and via the electronic interruption unit.

In particular, the present invention relates to low-voltage AC circuits having an AC voltage, customarily having a time-dependent sinusoidal AC voltage at a frequency f. The temporal dependence of the instantaneous voltage value u(t) of the AC voltage is described by the equation:

u(t)=U*sin (2π*f*t)
wherein:
u(t)=the instantaneous voltage value at time t
U=the voltage amplitude

A harmonic AC voltage can be represented by the rotation of a pointer, the length of which corresponds to the voltage amplitude (U). Instantaneous deflection is represented by the projection of the pointer on a coordinate system. An oscillation period corresponds to one full rotation of the pointer, and the full angle thereof is 2π (2 pi) or 360°. The angular frequency is the rate of variation of the phase angle of this rotating pointer. The angular frequency of a harmonic oscillation is always 2π-times the frequency thereof, such that:
ω=2π*f=2π/T=angular frequency of alternating voltage (T=period of oscillation)

In many cases, an indication of angular frequency (∫) is preferred over frequency (f), on the grounds that numerous formulae in oscillation theory, as a result of the involvement of trigonometric functions, the period of which, by definition, is 2π, can be represented in a more compact manner using the angular frequency:

u(t)=U*sin(ωt)

In the case of temporally non-constant angular frequencies, the term “instantaneous angular frequency” is also employed.

In a sinusoidal, particularly a temporally constant AC voltage, the time-dependent value given by the angular velocity ω and the time t corresponds to the time-dependent angle φ (t), which is also described as the phase angle φ(t). This means that the phase angle φ(t) periodically describes the range of 0 . . . 2π or 0°... 360°. This means that the phase angle periodically assumes a value between 0 and 2π, or between 0° and 360° (φ=n*(0 ... 2π) or φ=n*(0°... 360°), as a result of periodicity; in short: φ=0 ... 2π or φ=0°... 360°.

In consequence, the instantaneous voltage value u(t), or the instantaneous current value, or the instantaneous differential current value signifies the instantaneous value of the voltage at a time point t, i.e. in a sinusoidal (periodic) AC voltage, the value of the voltage at the phase angle φ (φ=0 ... 2π or φ=0°... 360°, for the respective period).

The object of the present invention is the improvement of a circuit-breaker of the above-mentioned type, particularly in the interests of ensuring the protection of persons against (fault) currents while simultaneously maintaining security of supply or the availability of electrical installations, i.e. the achievement of immunity against technically related (fault) currents which would result in the spurious tripping of the circuit-breaker. This means that, firstly, the protection of persons is ensured and, secondly, security of supply on a low-voltage circuit is improved. Alternatively, a novel concept for a circuit-breaker of this type is provided.

This object is fulfilled by a circuit-breaker having the features of patent claim 1, and by a method as claimed in patent claim 12.

According to the invention, a circuit-breaker for protecting a low-voltage electric circuit, in particular a low-voltage AC circuit is provided, comprising the following:
a housing, having grid-side and load-side terminals for conductors of the low-voltage circuit;
a differential current sensor unit for ascertaining the magnitude of a differential current in the conductors of the low-voltage circuit;
a mechanical break contact unit, which assumes a closed state of contacts for enabling a current flux in the low- voltage circuit, or an open state of contacts for preventing a current flux by the galvanic interruption of the low-voltage circuit;
the mechanical break contact unit, in particular, is operable and switchable by means of a mechanical handle, such that an opening of contacts for preventing a current flux or a closing of contacts for enabling a current flux in the low-voltage circuit is selectable (by means of the handle), and thus (in particular) a galvanic interruption of the low-voltage circuit is selectable;
in a mechanical break contact unit, an opening of contacts is also described as an isolation, and a closing of contacts is also described as a connection;
an electronic interruption unit which, on the circuit side, is connected in series with the mechanical break contact unit and which, by means of semiconductor-based switching elements, assumes a high-ohmic (in particular, a non-conducting) state of switching elements for preventing a current flux, or a low-ohmic state of switching elements for enabling a current flux in the low-voltage circuit;
in an electronic interruption unit, a high-ohmic (in particular, a non-conducting) state of switching elements (for preventing a current flux) is also described as a switched-off state (function: switch-off), and a low-ohmic (conducting) state of switching elements (for enabling a current flux) is also described as a switched-on state (function: switch-on);
a control unit, which is connected to the differential current sensor unit, to the mechanical break contact unit and to the electronic interruption unit.

According to the invention, the circuit-breaker, in particular the control unit, is configured such that, in the event of an overshoot of first differential current limiting values, or of first differential current-time limiting values, a prevention of a current flux in the low-voltage circuit is initiated by a high-ohmic state of the switching elements of the electronic interruption unit, with the break contacts in a closed state. Further to the prevention of a current flux by a high-ohmic state of switching elements of the electronic interruption unit, with the contacts in a closed state, a check is executed for the presence of an overshoot of second differential current limiting values or of second differential current-time limiting values.

This provides a particular advantage in that, further to a non-conforming differential current event which is caused, for example, by the contact of a person with a (phase) conductor (critical event), or by a technically related leakage current (which is not critical to persons, i.e. a non-critical event) (associated, for example, with the switching of capacitances), an instantaneous prevention of a current flux in the low-voltage circuit is initiated by a high-ohmic state of the switching elements of the electronic interruption unit.

In particular, the term “instantaneous prevention” of a current flux signifies the assumption of a high-ohmic state by the electronic interruption unit within 10 ms, in particular within 5 ms or 1 ms (existing fault current circuit-breakers typically trip after a time which is at least equal to/greater than 20 ms).

Further to the prevention of the current flux by means of a high-ohmic state of the switching elements of the electronic interruption unit and a closed state of the contacts, a check is executed for the presence of an overshoot of second differential current limiting values or of second differential current-time limiting values, such that a further check for the presence of non-conforming differential current events is thus executed and, optionally, a distinction is drawn between critical and non-critical events such that, firstly, the protection of persons and, secondly, the availability of installations are ensured.

The state in force on the load-side terminals can thus be further monitored with respect to the presence of differential current limiting values or of differential current-time limiting values. In the event of a change of state, advantageously, a further action can be executed, for example according to advantageous configurations of the invention.

Secondly, an entirely novel operating concept for a circuit-breaker is thus envisaged wherein, for example, conversely to existing fault current circuit-breakers, a check is also executed further to an event for the prevention of a current flux.

Advantageous configurations of the invention are disclosed in the sub-claims and in the exemplary embodiment.

Advantageously, by means of the mechanical handle, in particular, only the mechanical break contact unit is operable. A switch-on and switch-off by means of the electronic interruption unit cannot be executed (directly) on the device.

In an advantageous configuration of the invention, in the absence of an overshoot of second differential current limiting values or of second differential current-time limiting values over a first time range (10 ms ... 20 ms ... 30 ms ... 50 ms ... 100 ms . . . 200 ms ... 1 s (each value is possible, depending upon the application)), the electronic interruption unit executes a switchover to the low-ohmic state.

The first time range is, for example, a value within the range of 10 ms to 100 ms to 200 ms to 1 s. This means that, e.g. further to an overshoot of first differential current limiting values or of first differential current-time limiting values for 10 ms (15 ms) or 20 ms (25 ms, 30 ms, ..., 95 ms, 100 ms ... 1 s), in the event that second differential current limiting values or second differential current-time limiting values are not overshot, the electronic interruption unit executes a switchover to the low-ohmic state.

In particular, the first time range can be dependent upon the magnitude of the differential current thus determined (in particular, the r.m.s. value thereof), i.e. in the event of a higher differential current, the first time range is smaller.

This provides a particular advantage, in that an automatic reclosing is executed, in the event that non-critical differential current limiting values or differential current-time limiting values are in force. A high availability is achieved accordingly.

In an advantageous configuration of the invention, in the event that the overshoot of second differential current limiting values or of second differential current-time limiting values is in force for a first time period, the break contacts are opened.

The first time period, for example, lies within the range of 10 ms to 100 ms to 10 s. The first time period, in particular, can be shorter than 300 ms, 200 ms, 150 ms, 100 ms, 50 ms, 40 ms, 30 ms, 20 ms or 10 ms.

This provides a particular advantage, in that a switch-off behavior of the type associated with conventional fault current circuit-breakers is achieved, wherein a galvanic isolation is executed for the protection of persons.

In an advantageous configuration of the invention (further to the expiry of a/the first time period), in the event that an overshoot of second differential current limiting values or of second differential current-time limiting values is not in force (is absent) over a second time range, the electronic interruption unit executes a switchover to the low-ohmic state.

The second time range can be, for example, a value within the range of 20 ms to 100 ms to 1 s to 10 s. The length of the second time range can correspond to the length of the first time range, or can be longer.

This provides a particular advantage, in that an automatic reclosing is executed, and a high availability of the energy supply is achieved accordingly.

In an advantageous configuration of the invention, a communication unit, in particular an input unit, is provided. In the absence of an overshoot of second differential current limiting values or of second differential current-time limiting values over a (the) second time range, the electronic interruption unit will only execute a switchover to the low-ohmic state in the event that an acknowledgement has been executed by means of the communication unit, in particular the input unit.

The second time range can be a value within the range of 20 ms to 100 ms to 1 s. The length of the second time range can correspond to the length of the first time range, or can be longer.

This provides a particular advantage, in that a reclosing can be executed further to a confirmation (acknowledgement) by a user, and a high degree of security can thus be achieved.

In an advantageous configuration of the invention, the mechanical break contact unit (MK) is assigned to the load-side terminals.

This provides a particular advantage, in that an architecture which supports the behavior of the circuit-breaker according to the invention is provided, on the grounds that, on the one hand, although the current flux is interrupted in the event of a high-ohmic state of the interruption unit, by means of the (load-side) closed contacts, a continuing execution of a check according to the invention is nevertheless enabled (by means of the load-side terminals).

In an advantageous configuration of the invention, the check for the presence of an overshoot of second differential current limiting values or of second differential current-time limiting values on the load-side terminals is executed by the assumption of a low-ohmic state by at least one switching element, in particular by two or by all the switching elements of the electronic interruption unit, in particular for a first switch-on time.

This has a particular advantage, in that a simple option is provided for checking the presence of an overshoot of second differential current limiting values or of second differential current-time limiting values (on the load-side terminals), as it is only necessary for the existing electronic interruption unit to be switched to the low-ohmic state (in a short-term manner) in order to generate a short-term measuring current or measuring current for executing the check for differential current limiting values or differential current-time limiting values in force, and the magnitude thereof.

The first switch-on time can be sufficiently short, such that there is no endangerment of persons.

In an advantageous configuration of the invention, the check for the presence of an overshoot of second differential current limiting values or of second differential current-time limiting values (on the load-side terminals) by the assumption of a low-ohmic state by at least one switching element, in particular by two or by all the switching elements of the electronic interruption unit, is executed at a quantitative instantaneous voltage value which is lower than a first voltage threshold value. In particular, the first voltage threshold value is lower than 50 volts, or a (protective) low-voltage value. Advantageously, the first voltage threshold value is adjustable.

This provides a particular advantage, in that the check is executed at a voltage which is non-hazardous to persons, such that the security of both the circuit-breaker and of the low-voltage circuit is ensured.

Advantageously, a voltage sensor unit is further provided, which ascertains the voltage in the low-voltage circuit, in particular the magnitude of the voltage which is present on the grid-side terminals.

In an advantageous configuration of the invention, switching elements are restored to a high-ohmic state at a quantitative instantaneous voltage value which is higher than a second voltage threshold value.

In turn, this provides a particular advantage, in that the check is executed at a voltage which is non-hazardous to persons, such that the security of both the circuit-breaker and of the low-voltage circuit is ensured. The magnitude of the second voltage threshold value can correspond to the magnitude of the first voltage threshold value.

In an advantageous configuration of the invention, the check for the presence of an overshoot of second differential current limiting values or of second differential current-time limiting values (on the load-side terminals) is executed by the application of an auxiliary voltage, which is lower than a first voltage limit.

In turn, this provides a particular advantage, in that the check is executed by means of a further solution at a non- hazardous voltage to persons, such that the security of both the circuit-breaker and of the low-voltage circuit is ensured.

The magnitude of the first voltage limit can correspond to the magnitude of the first (or second) voltage threshold value.

In an advantageous configuration of the invention, the check for the presence of an overshoot of second differential current limiting values or of second differential current-time limiting values is executed at a time interval which, in particular, is 1, 3, 5, 10, 15 or 30 seconds, or 1, 5, 10 or 15 minutes wherein, in particular, the check at the first time interval is executed further to the expiry of a (the) first time period.

This provides a particular advantage, in that a cyclical check is executed over a longer period, without the execution of continuous test functions or test routines.

In an advantageous configuration of the invention, in the event of the (further) presence of an overshoot of second differential current limiting values or of second differential current-time limiting values, further to the expiry of a first time limit, the mechanical break contact unit executes a switchover to an open state of the break contacts. In particular, the first time limit is minutes, 30 minutes, 1 hour, 8 hours, 24 hours, 36 hours or 48 hours. Any intermediate value is possible. The first time interval is governed by the first time limit. This means that the first time interval is shorter than the first time limit. This provides a particular advantage in that, further to the expiry of the first time limit, a permanent or significant defect in the low-voltage circuit is inferred, and a secure state of the low-voltage circuit is initiated by means of galvanic isolation.

According to the invention, a corresponding method is claimed for a circuit-breaker for a low-voltage circuit, having electronic (semiconductor-based) switching elements, which method has identical and further advantages.

According to the method for a circuit-breaker for protecting a low-voltage electric circuit:
grid-side and load-side terminals for conductors of the low-voltage circuit are provided;
a mechanical break contact unit, which assumes a closed state of contacts for enabling a current flux in the low- voltage circuit, or an open state of contacts for preventing a current flux by the galvanic interruption of the low-voltage circuit, is provided;
an electronic interruption unit is provided which, on the circuit side, is connected in series with the mechanical break contact unit and which, by means of semiconductor-based switching elements, assumes a high-ohmic state of switching elements for preventing a current flux, or a low-ohmic state of switching elements for enabling a current flux in the low-voltage circuit;
wherein the magnitude of a differential current on the conductors of the low-voltage circuit is ascertained and, in the event 4 an overshoot of first differential current limiting values or of first differential current-time limiting values, a prevention of a current flux in the low-voltage circuit is initiated by a high-ohmic state of switching elements of the electronic interruption unit, with the break contacts in a closed state;
wherein, further to a prevention of a current flux by a high-ohmic state of switching elements of the electronic interruption unit, with the contacts in a closed state, a check is executed for the presence of an overshoot of second differential current limiting values or of second differential current-time limiting values.

In advantageous configurations of the invention:
in the absence of an overshoot of second differential current limiting values or of second differential current-time limiting values over a first time range (e.g. 20 ... 100 ms ... 1 s), the electronic interruption unit can execute a switchover to the low-ohmic state;
in the event of the presence of an overshoot of second differential current limiting values or of second differential current-time limiting values for a first time period which, in particular, is shorter than 300 ms, 200 ms, 150 ms, 100 ms, 50 ms, 40 ms, 30 ms, 20 ms or 10 ms, the break contacts can be opened;
in the absence of an overshoot of second differential current limiting values or of second differential current- time limiting values over a second time range (e.g. 20 ... 100 ms ... 1 s), a switchover to the low-ohmic state by the electronic interruption unit can only be executed further to the execution of an acknowledgement;
the check for the presence of an overshoot of second differential current limiting values or of second differential current-time limiting values (on the load-side terminals) can be executed by the assumption of a low-ohmic state of at least one switching element, in particular of two or of all the switching elements of the electronic interruption unit, in particular for a first switch-on time;
the check for the presence of an overshoot of second differential current limiting values or of second differential current-time limiting values (on the load-side terminals) can be executed by the assumption of a low-ohmic state of at least one switching element, in particular of two or of all the switching elements of the electronic interruption unit, at a quantitative instantaneous voltage value which is lower than a first voltage threshold value.

According to the invention, a corresponding computer program product for a circuit-breaker is claimed. The computer program product comprises commands which, upon the execution of the program by a microcontroller, initiate the execution by the latter, further to a prevention of a current flux by a high-ohmic state of switching elements of the electronic interruption unit, with the contacts in a closed state, of a check for the presence of an overshoot of second differential current limiting values or of second differential current-time limiting values, according to one of patent claims 1 to 17.

The microcontroller is an element of the circuit-breaker, in particular of the control unit.

According to the invention, a corresponding computer-readable storage medium is claimed, on which the computer program product is saved.

According to the invention, a corresponding data carrier signal is claimed, which is transmitted by the computer program product.

All configurations, whether in the dependent form relating to patent claims 1 to 12, or relating only to individual features or combinations of features of the patent claims, in particular any reference in the dependent claims to the independent claim with respect to the method, effect an improvement of a circuit-breaker, in particular an improvement of the safety of persons and of the security of supply in low-voltage circuits, and thus provide a novel and secure concept for a circuit-breaker.

The above-mentioned properties, features and advantages of the present invention, and the manner in which these are achieved, are further explained and clarified in conjunction with the following description of exemplary embodiments, which are described in greater detail with reference to the drawing.

### In the drawing:

FIG. 1 shows a first schematic representation of a circuit-breaker;

FIG. 2 shows a second schematic representation of a circuit-breaker;

FIGS. 3 to 8 show temporal characteristics for the explanation of the invention.

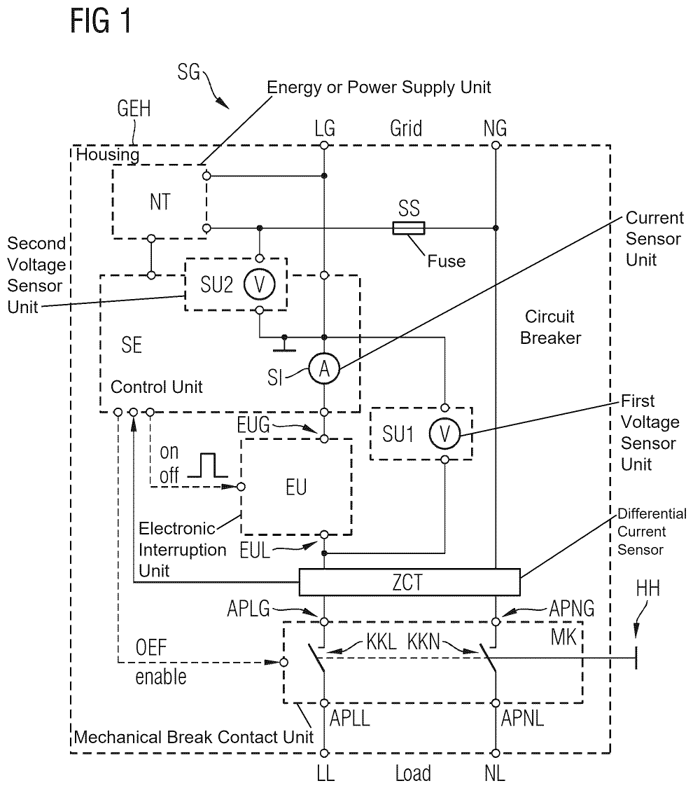

FIG. 1 shows a representation of a circuit-breaker SG for protecting a low-voltage electric circuit, in particular a low-voltage AC circuit, having a housing GEH, and comprising:
grid-side terminals which comprise, in particular, a grid-side neutral conductor terminal NG and a grid-side phase conductor terminal LG;
load-side terminals which comprise, in particular, a load-side neutral conductor terminal NL and a load-side phase conductor terminal LL;
terminals are provided for the low-voltage circuit;
at the grid-side terminals/grid side (GRID), an energy source is customarily connected;
at the load-side terminals/load side (LOAD), a load is customarily connected;
a (two-pole) mechanical break contact unit MK, having load-side connection points APLL, APNL, and grid-side connection points APLG, APNG;
wherein a load-side connection point APNL is provided for the neutral conductor, a load-side connection point APLL is provided for the phase conductor, a grid-side connection point APNG is provided for the neutral conductor, and a grid-side connection point APLG is provided for the phase conductor. The load-side connection points APNL, APLL are connected to the load-side neutral and phase terminals NL, LL, such that an opening of contacts KKN, KKL is switchable for preventing a current flux, or a closing of contacts KKN KKL is switchable for enabling a current flux in the low-voltage circuit;
an, in particular, single-pole electronic interruption unit EU (which, in particular, in the case of a single-pole embodiment, is arranged in the phase conductor),
having a grid-side connection point EUG, which is electrically connected to the grid-side phase conductor terminal LG, and
having a load-side connection point EUL, which is electrically bonded with, or electrically connected to the grid-side connection point APLG of the mechanical break contact unit MK, wherein the electronic interruption unit EU, by means of (unrepresented) semiconductor-based switching elements, assumes or is switchable to a high-ohmic state of switching elements, for preventing a current flux, or to a low-ohmic state of switching elements, for enabling a current flux in the low-voltage circuit;
a differential current sensor unit ZCT, for ascertaining the magnitude of a differential current on the conductors of the low-voltage circuit, which differential current sensor unit ZCT, in the example represented, is arranged between the electronic interruption unit EU and the mechanical break contact unit MK and, alternatively, can be provided (arranged) between the mechanical break contact unit MK and the load-side neutral and phase conductor terminals NL, LL and, further alternatively, can be provided (arranged) between the electronic interruption unit EU and the grid-side terminals NG, LG. The differential current sensor unit ZCT ascertains the magnitude of the differential current which is routed through the circuit-breaker to the conductors of the low-voltage circuit (which are to be protected). In the present example, a single-phase AC circuit is comprised of a neutral conductor and a phase conductor.

The differential current sensor unit ZCT can be a conventional summation current transformer. The primary side of the summation current transformer is formed by the conductors of the low-voltage circuit (in the present example, the neutral conductor and phase conductor). The secondary side of the summation current transformer is connected to the control unit SE;
a current sensor unit SI for ascertaining the magnitude of the current in the low-voltage circuit and which, in particular, is arranged in the current path of the phase conductor, or the phase conductor current path;
a control unit SE, which is connected to the differential current sensor unit ZCT, to the current sensor unit SI, to the mechanical break contact unit MK, and to the electronic interruption unit EU wherein, in the event of an overshoot of current and/or of current-time limiting values, a prevention of a current flux in the low-voltage circuit is initiated.

The mechanical break contact unit MK, in the present example, is arranged on the load side, and the electronic interruption unit EU, according to the invention, is arranged on the grid side.

Under normal circumstances, an electric voltage is applied to the grid side GRID, having the energy source. On the load side LOAD, an electrical load is customarily connected. This provides an advantage, in that no further (in particular, live) parts or components are located between the contacts of the mechanical break contact unit/load-side connection points (APLL, APNL) of the mechanical break contact unit and the two load-side terminals (LL, NL). By means of this architecture or design, it can thus be ensured that, where the contacts KKL, KKN are open, under no circumstances is a voltage present on the load-side terminals LL, NL. The safety of the circuit-breaker is enhanced accordingly.

Conversely, in other architectures, in which the mechanical break contact unit is arranged on the grid side, in many cases, electronic units (which are not galvanically isolated) are located up-circuit of the load-side terminal.

According to the invention, the circuit-breaker can be configured such that, moreover, the magnitude of the voltage across the electronic interruption unit can be ascertained. This means that the magnitude of a first voltage between the grid-side connection point EUG and the load-side connection point EUL of the electronic interruption unit EU can be ascertained, or is ascertained.

To this end, in the example according to FIG. 1, a first voltage sensor unit SU1 is provided, which is connected to the control unit SE, and which ascertains the magnitude of the voltage between the grid-side connection point EUG and the load-side connection point EUL of the electronic interruption unit EU.

For the voltage measurement by the first voltage sensor unit SU1, alternatively, the voltage across the series-connected arrangement of the electronic interruption unit EU and the current sensor SI can also be ascertained, as represented in FIG. 1. The current sensor unit SI has a very low internal resistance, such that ascertainment of the magnitude of voltage is not impaired, or is only impaired to a negligible extent.

Advantageously, a second voltage sensor unit SU2 can be provided, which ascertains the magnitude of the voltage between the grid-side neutral conductor terminal NG and the grid-side phase conductor terminal LG.

The first voltage sensor unit can also be replaced, wherein two voltage measurements (up-circuit of the electronic interruption unit and down-circuit of the electronic interruption unit) are employed. The voltage across the electronic interruption unit is ascertained by a differential formation.

A/the second voltage sensor unit SU2, which is connected to the control unit SE, is thus provided, which ascertains the magnitude of a second voltage between the grid-side neutral conductor terminal NG and the grid-side phase conductor terminal LG. Moreover, an (unrepresented) third voltage sensor unit SU3 can be provided, which is connected to the control unit, and which ascertains the magnitude of a third voltage between the grid-side neutral conductor terminal NG and the load-side connection point EUL of the electronic interruption unit EU. The circuit-breaker is configured such that, from the difference between the second and the third voltage, the magnitude of a/the first voltage between the grid-side connection point EUG and the load-side connection point EUL of the electronic interruption unit EU is ascertained.

Between the grid-side connection points APLG, APNG of the mechanical break contact unit MK, a measuring impedance ZM can be connected. The measuring impedance ZM can be, for example, an electrical resistor and/or a capacitor. The measuring impedance can moreover be an inductance. In particular, the measuring impedance can comprise a series-connected arrangement or a parallel-connected arrangement of a resistor and/or a capacitor and/or an inductance.

In the example according to FIG. 1, the electronic interruption unit EU is embodied as a single-pole unit, in the present example, in the phase conductor. The grid-side connection point APNG for the neutral conductor of the mechanical break contact unit MK is thus connected to the grid-side neutral conductor terminal NG of the housing GEH. According to FIG. 1, this connection is executed by the differential current sensor unit ZCT, for example by the summation current transformer thereof.

The circuit-breaker SG is advantageously configured such that the contacts of the mechanical break contact unit MK are opened by means of the control unit SE, but cannot be closed, as indicated by an arrow between the control unit SE and the mechanical break contact unit MK.

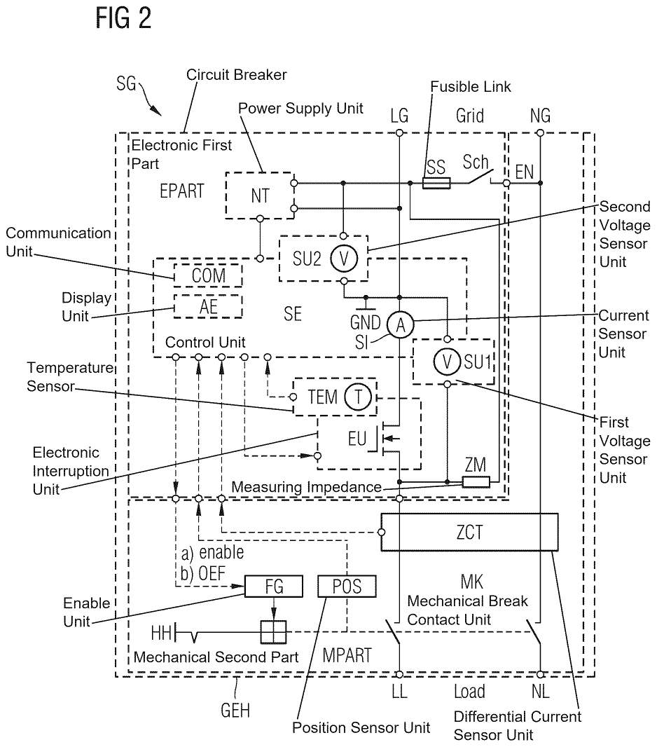

The mechanical break contact unit MK is operable by means of a mechanical handle HH on the circuit breaker SG, in order to execute a manual (hand-operated) opening or closing of the contacts KKL, KKN. The mechanical handle HH indicates the circuit state (open or closed) of the contacts of the mechanical break contact unit MK on the circuit-breaker. Moreover, the contact position (or the position of the handle, whether closed or open) can be communicable to the control unit SE. The contact position (or the position of the handle) can be ascertained e. g. by means of a sensor, such as a position sensor. The contact position or the circuit state can be communicated to the control unit SE. The position sensor can be an element of the break contact unit MK. Alternatively, the position sensor can be a component in an electronic first part (EPART, FIG. 2). For example, in the electronic first part (EPART), a Hall effect sensor can be provided, which executes the contactless capture and communication of the position of the contacts and/or of the handle.

The mechanical break contact unit MK is advantageously configured such that a (manual) closing of the contacts by means of the mechanical handle is only possible further to a release (enable command), in particular further to an enable signal. This is also indicated by the arrow between the control unit SE and the mechanical break contact unit MK. This means that the contacts KKL, KKN of the mechanical break contact unit MK can only be closed by means of the handle HH in the event that an enable command or enable signal (delivered by the control unit) is in force. In the absence of this enable command or enable signal, the handle HH can be actuated, but the contacts will not be closed (“continuous slider” action).

The circuit-breaker SG comprises an energy supply or power supply unit NT, for example a switched-mode power supply. In particular, the energy supply/power supply unit NT is provided for the control unit SE, which is indicated by a connection between the energy supply/power supply unit NT and the control unit SE in FIG. 1. The energy supply/power supply unit NT (secondly) is connected to the grid-side neutral conductor terminal NG and to the grid-side phase conductor terminal LG. In the connection to the grid-side neutral conductor terminal NG (and/or to the phase conductor terminal LG), advantageously, a fuse SS, in particular a fusible link, or a switch SCH (FIG. 2) can be provided. According to the invention, under normal circumstances, the power supply unit NT is permanently supplied with energy, specifically from the grid-side terminals. Optionally, it is protected by the fuse SS, or can be disconnected by means of the switch SCH.

Advantageously, the switch SCH/Sch can be embodied such that the switch can only be opened if the contacts are in the open state. This enhances the security of the device, as the electronics (in particular the control unit) cannot be switched off when the contacts are closed.

The intended function of the fuse SS is not only the protection - of the energy supply from the power supply unit NT, but also, particularly in the case of a two-part circuit layout (see FIG. 2), the protection of the “electronic” first part EPART or, in particular, of all the constituent units thereof (including, specifically, the control unit, the electronic interruption unit, the voltage sensor(s), the current sensors, optionally the measuring impedance, etc.).

Alternatively, the measuring impedance ZM, via the fuse SS, can be connected to the grid-side neutral conductor terminal NG. Advantageously, a three-pole electronics unit or an electronic first part EPART (FIG. 2) can thus be embodied, for example in the form of a module, which comprises three terminals in relation to the low-voltage circuit-one neutral conductor terminal and two phase conductor terminals. The electronic first part EPART can comprise further terminals, in particular for control or measurement information, such as terminals for an enable signal “Enable”/enable command, an opening signal OEF, positional information (delivered by the position unit POS) and/or a differential current signal (magnitude of the differential current) delivered by the differential current sensor unit ZCT.

The electronics unit or the electronic first part EPART (FIG. 2) comprises, for example, the electronic interruption unit EU, the control unit SE, the power supply unit NT (in particular, including the fuse SS), the current sensor unit SI, optionally the first voltage sensor unit SU1 and/or optionally the second voltage sensor unit SU2.

With respect to the three terminals relating to the low-voltage circuit of the electronic first part EPART, an advantage is thus provided, in that only two phase conductor terminals are required to assume a high current-carrying capacity (a number of amperes, in order to conduct the load current), whereas the neutral conductor terminal is only required to assume a (comparatively) low current-carrying capacity (for example lower than 1 A, or a few mA—depending upon the energy demand of the control unit). This simplifies construction, and enhances the security of the device on the grounds that, in the event of a fault on the electronic first part EPART, no high short-circuit current can flow via this connection.

The low-voltage circuit can be a three-phase AC circuit, having a neutral conductor and three phase conductors. To this end, the circuit-breaker can be configured as a three-phase variant and, for example, can comprise further grid-side and load-side phase conductor terminals. Between the further grid-side and load-side phase conductor terminals, in an analogous manner, electronic interruption units and contacts of the mechanical break contact unit according to the invention are provided in each case. The respective conductors (three phase conductors L1, L2, L3, and the neutral conductor N) are led through the differential current unit ZCT. Current sensor units and voltage ascertainment functions (e.g. by means of first voltage sensor units) can also be provided.

The term “high-ohmic” signifies a state in which only a current of negligible magnitude continues to flow. In particular, the term “high-ohmic” signifies resistance values greater than 1 kiloohm, preferably greater than 10 kiloohms, 100 kiloohms, 1 megaohm, megaohms, 100 megaohms, 1 gigaohm, or greater.

The term “low-ohmic” signifies a state in which the current value which is indicated on the circuit-breaker can flow. In particular, the term “low-ohmic” signifies resistance values which are lower than ohms, preferably lower than 1 ohm, 100 milliohms, 10 milliohms, 1 milliohm, or lower.

FIG. 2 shows a representation according to FIG. 1, with the distinction that the circuit-breaker is of a two-part design. The circuit-breaker contains an electronic first part EPART, for example arranged on a PCB/printed circuit board. The first part EPART can comprise the control unit SE, the first voltage sensor unit SU1, the second voltage sensor unit SU2, the current sensor unit SI, the electronic interruption unit EU, and the power supply unit NT. The first part can further comprise the fusible link SS, a switch SCH, the measuring impedance ZM, a temperature sensor TEM (in particular for the electronic interruption unit EU), a communication unit COM, a display unit AE and, by way of a variant, a position sensor unit POS.

The electronic first part EPART comprises only three terminals for connecting to the low-voltage circuit:
the grid-side phase conductor terminal LG, by way of a first terminal;
a (second) terminal for the, or to the grid-side phase conductor connection point APLG of the mechanical break contact unit MK;

a third terminal EN, for connecting to the grid-side neutral conductor terminal NG.

The two terminals: terminal LG to the grid-side phase conductor, and the terminal for the, or to grid-side phase conductor connection point APLG, assume a high current-carrying capacity, e.g. of a number of amperes, and greater than 10 A/16 A—depending upon the nominal current or rated current of the low-voltage circuit, in particular, in order to carry the load current, even in the event of a short-circuit or an overload.

The third terminal EN for connecting to the grid-side neutral conductor terminal NG assumes a (comparatively) low current-carrying capacity, e. g. lower than 1 A, or a few mA
depending upon the energy demand of the units supplied, specifically in the electronic first part EPART. The third terminal EN is embodied with a low current-carrying capacity, in order to supply the power supply unit with power, and to enable a voltage measurement between the phase conductor and the neutral conductor of the low-voltage circuit. In particular, this third terminal EN is protected by a fuse SS. This can be embodied in the form of a fusible link, or in the form of a cost-effective printed conductor fuse (a thin printed conductor having a corresponding length and thickness on the printed circuit board). This provides a particular advantage in that, as a result of the low current-carrying capacity of this conductor or on this third terminal EN, protection against a short-circuit which occurs within the electronic first part (EPART) (or on the (electronic) units), e.g. on the side of the power supply unit or of the control unit, is improved.

This means that, in the event of a loss or failure of an electronic component of a unit within the electronic first part EPART, no hazardous short-circuit current can occur (fed by the grid-side terminals LG, NG), which might result in a fire in the device.

This short-circuit current is fed by the grid, via the grid-side terminals. In many cases, an up-circuit circuit-breaker assumes a far higher trip current, and supplies low-voltage circuits which are arranged in parallel. Accordingly, in the event of a fault in the circuit-breaker (the circuit-breaker of the protected low-voltage circuit) and the tripping of the up-circuit circuit-breaker, other non-defective parallel circuits would also be tripped, which tripping can thus be prevented.

In particular, the communication unit COM can be a wireless communication unit. The communication unit COM can comprise a (manual) input unit on the circuit-breaker, for the (manual) acknowledgement of states on the circuit-breaker SG. Acknowledgement can also be executed (in a hard-wired and/or wireless arrangement) by means of the communication unit COM.

The communication unit COM can further comprise a display function. A separate display unit can also be provided. The circuit-breaker incorporates an, in particular mechanical second part MPART. The second part MPART can comprise the mechanical break contact unit MK, the handle HH, and an enable unit FG. The second part can further comprise a position unit POS, for notifying the position of the contacts of the mechanical break contact unit MK to the control unit, and the (neutral conductor) connection(s). The second part MPART comprises the differential current sensor unit ZCT, such as a summation current transformer, of the type which is known, for example, from conventional fault current circuit breakers. Further units, which are not illustrated in greater detail, can be provided.

By means of the two-part structure, advantageously, a compact circuit-breaker according to the invention can be embodied, having a simplified construction.

The enable unit/enable function FG enables the actuation of the contacts of the mechanical break contact unit by means of the handle HH, in the event that an enable signal “enable” is present. This means that a closing of the contacts KKL, KKN by means of the handle will only be possible in the event of the presence of the enable signal “enable” (delivered by the control unit SE). Otherwise, closing is not possible (continuous slider action of the handle HH). The contacts will remain in the open position/circuit state. Moreover, the enable unit FG can execute an opening of the contacts (second function of the enable unit FG), in the event that an opening signal OEF (delivered by the control unit SE) is present. In this case, the enable unit/enable function FG functions as a trip unit for opening the contacts of the mechanical break contact unit MK.

The circuit-breaker SG, in particular the control unit SE, is configured such that, in the event of an overshoot of current limiting values or of current-time limiting values (i.e. where a current limiting value is exceeded for a specific time period) a prevention of a current flux in the low-voltage circuit is initiated, in particular in order to prevent a short-circuit. In particular, this is achieved by means of the switchover of the electronic interruption unit EU from the low-ohmic state to the high-ohmic state. Initiation of the prevention of a current flux in the low-voltage circuit is executed, for example, by a first interruption signal, which is transmitted by the control unit SE to the electronic interruption unit EU.

Alternatively or additionally, the mechanical break contact unit MK can be actuated by the control unit SE, in order to initiate a prevention of a current flux in the low-voltage circuit in the event of an overshoot of current limiting values or of current-time limiting values. Specifically, a galvanic isolation is optionally effected. Initiation of the prevention of a current flux or, optionally, of a galvanic interruption of the low-voltage circuit is executed, for example, by a second interruption signal, which is transmitted by the control unit SE to the mechanical break contact system MK.

The electronic interruption unit EU can comprise semiconductor components, such as bipolar transistors, field-effect transistors (FETs), isolated gate bipolar transistors (IGBTs), metal-oxide semiconductor field-effect transistors (MOSFETs) or other (self-commutated) power semiconductors. In particular, on the grounds of their low forward resistances, high junction resistances and effective switching behavior, IGBTs and MOSFETs are particularly appropriate for the circuit-breaker according to the invention.

In particular, by means of the mechanical break contact unit MK, a (regulation) isolating function is signified, which is embodied by the break contact unit MK. The term “isolating function” signifies the following points:
a regulation (voltage-dependent) minimum contact gap (minimum clearance of contacts);
a contact position indication of the contacts of the mechanical break contact system;
a facility for the opening of the mechanical break contact system at all times (no immobilization of the break contact system—in particular by means of the handle, trip-free mechanism).

Within the meaning of the invention, for the isolating function and the properties thereof, the standard series DIN EN 60947 or IEC 60947 are applicable, the consideration of which is included herein by reference.

The circuit-breaker can be configured as a top hat rail-mounted circuit-breaker SG having a width of e.g. 1 HP, 1.5 HP or 2 HP, with two-pole terminals (L, N). In electrical installations and switch cabinet construction, the width of built-in devices, such as circuit-breakers, line circuit-breakers, fault current circuit-breakers, etc., is expressed in units of horizontal pitch, or HP for short. The width of a unit of horizontal pitch is ~18 mm. According to DIN standard 43880:1988-12, the built-in width of devices is intended to lie between 17.5 and 18.0 mm, or calculated herefrom by the multiplication of this dimension by 0.5, or by a whole-number multiple, i.e.: k×0.5×18 mm or k×0.5×17.5 mm (where k=1, 2, 3, ...) . Thus, for example, a single-pole line circuit-breaker according to the prior art has a width of 1 HP. According to DIN 43871 “Consumer units for built-in equipment up to 63 A”, built-in units of electrical installation distribution boards are matched to units of horizontal pitch, e.g. the width of mounting rails/top hat rails.

According to the invention, the circuit-breaker SG, in particular the control unit SE, is configured such that, in the event of an overshoot first differential current limiting values or of first differential current-time limiting values, a prevention of a current flux in the low-voltage circuit is initiated by the assumption of a high-ohmic state by switching elements of the electronic interruption unit, with the break contacts in a closed state. First differential current limiting values or first differential current-time limiting values can be limiting values according to applicable standards, such as DIN EN 61008-1. These are, for example, 30 mA for the protection of persons in Europe in a 230 V low-voltage circuit, 6 mA for the protection of persons in North America, and 300 mA for fire protection (230 V r.m.s.).

Further to the prevention of a current flux by means of a high-ohmic state of switching elements of the electronic interruption unit, with the contacts in a closed state, a check is executed for the presence of an overshoot of second differential current limiting values or of second differential current-time limiting values.

The magnitude of second differential current limiting values or of second differential current-time limiting values can correspond to the magnitude of first differential current limiting values or first differential current-time limiting values. Advantageously, however, according to the invention, the magnitude of second differential current limiting values or of second differential current-time limiting values is lower than the magnitude of first differential current limiting values or of first differential current-time limiting values.

The magnitude of second differential current limiting values or of second differential current-time limiting values advantageously corresponds to regulation values, albeit of a lower magnitude than that which results from the check. If the check is executed, for example, at a low voltage, particularly at a protective low voltage, smaller differential currents will also be generated as a result. This means that the magnitude of second differential current limiting values or of second differential current-time limiting values is dictated by the magnitude of voltage during testing. The higher the voltage, the higher the magnitude of second differential current limiting values or of second differential current-time limiting values. In the event that, for the (short-term) check, the grid voltage of the low-voltage circuit, e.g. 230 volts, is employed, the magnitude of second differential current limiting values or of second differential current-time limiting values corresponds to that of first differential current limiting values or of first differential current-time limiting values.

According to the invention, the check for the presence of an overshoot of second differential current limiting values or of second differential current-time limiting values (on the load-side terminals) can be executed by the assumption of a low-ohmic state by at least one switching element, in particular by two or by all the switching elements of the electronic interruption unit (EU), in particular for a first switch-on time.

The first switch-on time can be established such that the r.m.s. value of the voltage which is present on the load terminals (ascertained over a system period) does not exceed 50 V. This means that the instantaneous voltage value can exceed 50 V in a short-term manner, but that the r.m.s. value of voltage ascertained over a system period is lower than 50 volts. Accordingly, the first switch-on time is consistently shorter than ms, specifically shorter than 10 ms and, in particular, shorter than 1 ms.

The check for the presence of an overshoot of second differential current limiting values or of second differential current-time limiting values (on the load-side terminals) can be executed by the assumption of a low-ohmic state by at least one switching element, in particular by two, or by all the switching elements of the electronic interruption unit (EU) at a quantitative instantaneous voltage value which is lower than a first voltage threshold value (with respect to an AC voltage). The electronic interruption unit can be switched on in a short-term manner, i.e. the semi-conductor-based switching element undergoes a short-term switching to a low-ohmic state. In this context, short-term signifies a specific first switch-on time ED1, during which the instantaneous voltage value u (t) of the AC voltage does not exceed a specific value, e.g. of 50 volts. Thus, for example, at the zero-crossing of the AC voltage (0°), the AC voltage can be switched-on for approximately 444 us/up to 8° (with the electronic interruption unit EU in a low- ohmic state), i.e. until the instantaneous voltage value achieves a maximum of 50 volts.

Alternatively, at approximately −8° (relative to the zero-crossing of the AC voltage), a switch-on can also be executed, the passage through the zero-crossing can proceed and, at +8°, a further switch-off can be executed, i.e. for a duration of approximately 888 μs. This means that the switch-on time period is shorter than 1 ms, in particular shorter than 0.9 ms, or is specifically approximately 0.8 ms (or one half of these respective values, depending upon the switch-on time point in each case).

By means of the short-term switch-on of the electronic interruption unit, a reduced (test) voltage is applied to the load-side terminals (load terminals). The r.m.s. value of this test voltage is governed by the grid voltage in force and the first switch-on time ED1, and is consistently lower than the grid voltage in force. The first switch-on time or the first voltage threshold value are thus selected such that the r.m.s. value of the test voltage (which is applied to the grid-side terminals) is lower than 50 V. A secure test for the presence of an overshoot of second differential current limiting values or of second differential current-time limiting values can thus be executed.

In the present example, second differential current limiting values or second differential current-time limiting values are adapted to a voltage of 50 V. The reduction of the second differential current limiting value in comparison with the first differential current limiting value corresponds to the same ratio as the reduction of the reduction of the test voltage in relation to the nominal grid voltage. This means that, at a test voltage e. g. 50 V r.m.s. and a nominal grid voltage of 230 V, the second differential current limiting value is reduced by 50/230. From e.g. 30 mA (by way of a first differential current limiting value), this gives 30 mA*50/230=6.5 mA (by way of a second differential current limiting value).

This means that the second differential current limiting value is lower than the first differential current limiting value. Alternatively or additionally, the switching elements, at a quantitative instantaneous voltage value which exceeds a second voltage threshold value (such as e.g. 50 volts), can resume a high-ohmic state.

Alternatively, the check of at least one electrical parameter on the load-side terminals can be executed by the application of an auxiliary voltage, in particular a pulsed DC voltage, which is lower than a first voltage limit. The magnitude of the first voltage limit can be a (limiting) value of the protective low voltage, or can correspond to the voltage threshold value. Here again, according to the invention, no hazardous voltage is present on the load-side terminals.

The first voltage limit can be, for example, 50 volts.

In the absence of an overshoot of second differential current limiting values; or of second differential current-time limiting values over a first time range ZB1, the electronic interruption unit EU can execute a switchover to the low-ohmic state. (Alternatively, the check can be executed until such time as second differential current limiting values or second differential current-time limiting values are undershot. The electronic interruption unit then executes a switchover to the low-ohmic state.) Conversely, in the event of the presence of an overshoot of second differential current limiting values or of second differential current-time limiting values for a first time period ZS1, the break contacts are opened (for galvanic isolation, as per a conventional fault current circuit-breaker).

The value of the first time period can correspond to the value of the first time range, i.e. further to the expiry of the first time period (=the first time range), the contacts of the mechanical break contact unit can open. The first time period can also assume a different value. For example, the first time period can be a time period which is compliant with standards for conventional fault current protection/for conventional fault current circuit-breakers. Reference may be made to DIN/EN standard 61008-1, “Specification for residual current operated circuit-breakers without integral overcurrent protection for household and simi-lar uses (RCCBs)”, in particular part 1, “General rules”, which is included herein by way of reference. For example, it proceeds from this standard that a 30 mA fault current circuit-breaker (residual current device, or RCD), at a rated fault current of 30 mA, is required to trip within 300 ms, at two-times the rated fault current (60 mA) within 150 ms, and at a five-fold value, or higher, within 40 ms.

For example, the first time period can be shorter than 300 ms, 150 ms, 100 ms, 40 ms, 30 ms, 20 ms or 10 ms. A standard-compliant, or superior performance can thus be delivered wherein, for example, the execution of an interruption is only required e.g. after 300 ms. Previously, according to the invention, a further check can be executed for the presence of an overshoot of differential current limiting values or of differential current-time limiting values, e.g. with no breach of standards. A superior security of supply can thus be achieved, particularly in the event of non-critical events.

For example, the first time period ZS1, depending upon the application, can assume a value within the range of 10 ms to 10 s, specifically 10 ms to 40 ms, or 40 ms to 150 ms, or 150 ms to 300 ms, or 1 s to 10 s.

The circuit-breaker SG can comprise a communication unit COM, in particular an input unit. In the absence of an overshoot of second differential current limiting values or of second differential current-time limiting values over a second time range, for example a value within the range of 20 ms ... 100 ms ... 1 s ... 10 s ... 100 s, the electronic interruption unit EU will only execute a switchover to the low-ohmic state in response to the execution of an acknowledgement Q1 (e.g. by an operator or user) using the communication unit COM, in particular the input unit. The communication unit (input unit) can comprise input elements on the housing of the circuit-breaker. The communication unit can comprise or additionally comprise a hard-wired (e.g. electrical, optical) or wireless (e.g. radio, optical) input facility. The communication unit (input unit) can also comprise a display function.

Alternatively or additionally, further to the expiry of the first time period ZS1, the electronic interruption unit EU will only execute a switchover for the resumption of the low-ohmic state (EUn) in the event that the absence of an overshoot of second differential current limiting values or of second differential current-time limiting values for the duration of a (first (or) second) time range has been confirmed. Moreover, further to the expiry of the first time period ZS1, an acknowledgement (Q1) of fault-free status can be executed (or may be required) before the electronic interruption unit EU executes a switchover for the resumption of the low-ohmic state (EUn).

The circuit-breaker SG, in particular the control unit SE, can comprise a microcontroller (=microprocessor), on which a computer program product runs, which computer program product comprises commands which, upon the execution of the program by the microcontroller, initiate the execution by the latter of a check (as described heretofore and herein-after) of a circuit-breaker.

The computer program product can advantageously be saved on a computer-readable storage medium, such as a USB stick, a CD-ROM, etc., in order to enable e.g. an upgrade to an extended version.

Alternatively, the computer program product can also be advantageously transmitted by means of a data carrier signal.

The control unit SE can be embodied:
in the form of a digital circuit, e.g. in the form of a (further) microprocessor; the (further) microprocessor can also contain an analog component;
in the form of a digital circuit, having analog circuit components.

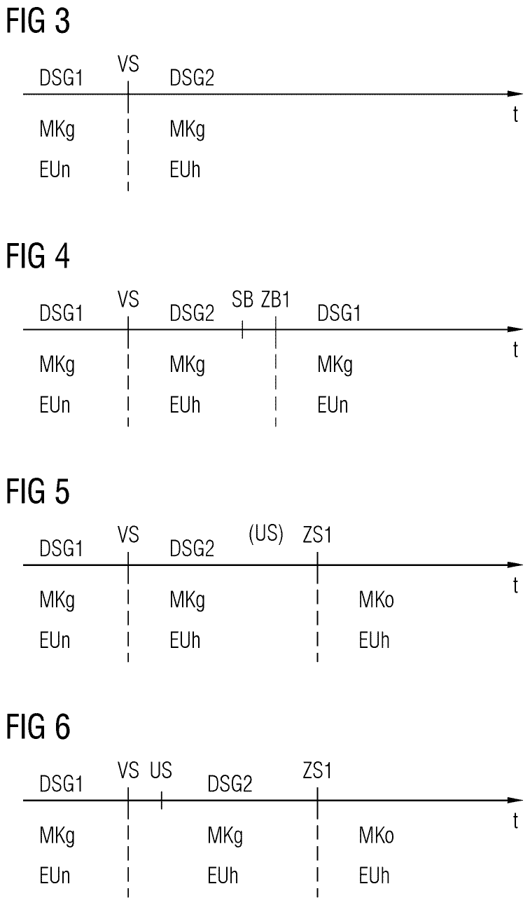

In FIGS. 3 to 8, an exemplary section of the above-mentioned temporal characteristics is represented. Each of FIGS. 3 to 8, represents a timeline t, on which specific and above-mentioned time points are plotted, which FIG. further include entries with respect to evaluations of first differential current limiting values or of first differential current-time limiting values DSG1, or of second differential current limiting values or of second differential current-time limiting values DSG2 and, additionally, states of the mechanical break contact unit MK and of the electronic interruption unit EU.

FIG. 3 shows the time point of an interruption of a current flux VS, which occurs in response to an overshoot of first differential current limiting values or of first differential current-time limiting values DSG1. Prior to the time point of the prevention of the current flux VS, the mechanical break contact unit MK assumes a closed state MKg of contacts, and the electronic interruption unit EU assumes a low-ohmic state EUn of switching elements, in order to enable a current flux in the low-voltage circuit. Further to the prevention of the current flux VS, the mechanical break contact unit MK maintains a closed state MKg of contacts (for a potentially recurrent current flux/in order to restore a rapid enablement of the current flux), and the electronic interruption unit EU maintains a high-ohmic state EUh of switching elements, in order to prevent the current flux. Further to the prevention of the current flux VS, a check is executed for the presence of an overshoot of second differential current limiting values or of second differential current-time limiting values DSG2 (on the load-side terminal).

FIG. 4 shows a representation according to FIG. 3, with the following distinctions.

Further to the initiation of the prevention of a current flux VS and the subsequent absence (at an arbitrary subsequent time point) of an overshoot SB of second differential current limiting values or of second differential current-time limiting values DSG2 (i.e. if second differential current limiting values or second differential current-time limiting values DSG2 lie within the target range), the electronic interruption unit EU executes a switchover to the low-ohmic state EUn, particularly in the event that the absence of an overshoot SB of second differential current limiting values or of second differential current-time limiting values DSG2 has been in force over a first time range ZB1, as plotted in FIG. 4. The first time range ZB1 can be very short (i.e. a virtually instantaneous reclosing can occur), or can also be temporally adjustable, in consideration of security.

The check for the presence of the overshoot of second differential current limiting values or of second differential current-time limiting values DSG2 is executed for such time until the overshoot is no longer in force (SB). This can continue until the electronic interruption unit EU executes a switchover to the low-ohmic state EUn (ZB1). Thereafter, a further check is executed with respect to first differential current limiting values or first differential current-time limiting values DSG1.

In the present case, the mechanical break contact unit MK assumes a closed state of the (break) contacts MKg over the entire time period.

FIG. 5 shows a representation according to FIG. 3, with the distinction that, further to a prevention of a current flux VS and in the event of the presence of an overshoot US of second differential current limiting values or of second differential current-time limiting values DSG2 for a first time period ZS1 which, in particular, is shorter than 300 ms, 150 ms, 40 ms, 30 ms, 20 ms or 10 ms, the contacts of the mechanical break contact unit are opened (MKo). In the present example, the electronic interruption unit EU remains in a high-ohmic state EUh (further to the prevention of the current flux VS).

FIG. 6 shows a representation according to FIG. 5, with the distinction that the presence of the overshoot US of second differential current limiting values or of second differential current-time limiting values DSG2 does not occur immediately further to the prevention of a current flux VS, but at a later time point, which is nevertheless in advance of the (expiry of the) first time range ZB1 (i.e. prior to the assumption of a low-ohmic state by the electronic interruption unit EU). In the event of the presence of the overshoot US of second differential current limiting values or of second differential current-time limiting values DSG2 for the first time period ZS1, an opening of the contacts MKo of the mechanical break contact unit MK is executed (after the first time period ZS1).

This means that a switchover between the overshoot (US)/absence of an overshoot SB of second differential current limiting values or of second differential current-time limiting values DSG2 might be in force. If second differential current limiting values or second differential curlrent-time limiting values DSG2 are exceeded for the first time period ZS1, an opening of the contacts MKo of the mechanical break contact unit MK is executed.

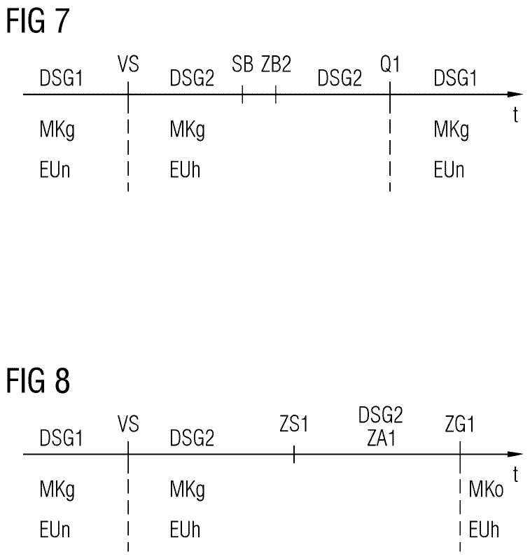

FIG. 7 shows a representation according to FIG. 4, with the distinction that, further to the occurrence of the prevention of a current flux VS and the subsequent absence of an overshoot SB of second differential current values or of second differential current-time limiting values DSG2 (i.e. if second differential current limiting values or second differential current-time limiting values DSG2 lie within the target range wherein, in particular, it is intended that this condition should be in force prior to the expiry of the first time period ZS1, i.e. before the contacts are opened), the electronic interruption unit EU will then execute a switchover to the low-ohmic state EUn, in the event that the absence of an overshoot SB of second differential current limiting values or of second differential current-time limiting values DSG2 has been in force over a second time range ZB2 (which can correspond to the first time range ZB1), and an acknowledgement (Q1) has been executed (by means of the communication unit COM, in particular the input unit).

The check for the presence of the overshoot of second differential current limiting values or of second differential current-time limiting values DSG2 is executed for such time until the overshoot is no longer in force (SB) and/or the second time range has expired and/or the acknowledgement is executed. This means that the check for the presence of the overshoot of second differential current limiting values or of second differential current-time limiting values DSG2 can be continued until the electronic interruption unit EU executes a switchover to the low-ohmic state EUn (in the present example, Q1). Thereafter, a further check is executed with respect to first differential current limiting values or first differential current-time limiting values DSG1.

In the present case, the mechanical break contact unit MK assumes a closed state of the (break) contacts MKg over the entire time period.

FIG. 8 shows a representation according to FIG. 5 or 6, with the distinction that, in the event of the presence of the overshoot US of second differential current limiting values or of second differential current-time limiting values DSG2 and the expiry of the first time period ZS1, the contacts of the mechanical break contact unit are not opened, i.e. remain closed. Moreover, further to the expiry of the first time period ZS1, the check for the presence of the overshoot US of second differential current limiting values or of second differential current-time limiting values (DSG2) is executed at a first time interval ZA1 (i.e. not continuously).

Moreover, in the event of the continuing presence of the overshoot US of second differential current limiting values or of second differential current-time limiting values DSG2 (at least in the event that, over the first or second time range ZB1, ZB2, the absence of an overshoot is not in force), further to the expiry of a first time limit ZG1, the mechanical break contact unit MK executes a switchover to an open state of the contacts MKo.

This means that, further to the expiry of the first time period ZS1, the check is executed at a first time interval ZA1, until the first time limit ZG1 is achieved. Further to the expiry of the first time limit ZG1, the mechanical break contact unit MK executes a switchover to an open state MKo, provided that the overshoot US of second differential current limiting values or of second differential current-time limiting values DSG2 remains in force. The electronic interruption unit EU remains in the high-ohmic state EUh (with effect from the prevention of the current flux VS).

In an analogous manner, further means of operation or means of procedure will be combinable by a person skilled in the art.

According to the invention, the check for the presence of the overshoot of second differential current limiting values or of second differential current-time limiting values DSG2 is advantageously executed by the assumption of a low-ohmic state by at least one switching element, in particular by two, or by all the switching elements of the electronic interruption unit EU for a first switch-on time ED1. This means that the high-ohmic state EUh of the electronic interruption unit EU, as plotted in the figures, does not signify a continuous high-ohmic state, but rather the short-term assumption of a high-ohmic state by the electronic interruption unit EU (for the first switch-on time ED1). The first switch-on time ED1, for example, is very short (in relation to other time intervals), such that there is no resulting contravention of the representation according to the figures and the fundamental mode of operation.

Although the invention has been illustrated and described in greater detail with reference to the exemplary embodiment, the invention is not limited by the examples disclosed, and further variations can be inferred herefrom by a person skilled in the art, without departing from the protective scope of the invention.

1-20. (canceled)

21. A circuit-breaker for protecting a low-voltage electric circuit, the circuit-breaker comprising:
a housing having grid-side and load-side terminals for conductors of the low-voltage circuit;
a differential current sensor unit for ascertaining a magnitude of a differential current in the conductors of the low-voltage circuit;
a mechanical break contact unit having break contacts assuming a closed state for enabling a current flux in the low-voltage circuit, or an open state for preventing the current flux by a galvanic interruption of the low-voltage circuit;
an electronic interruption unit having a circuit side connected in series with said mechanical break contact unit, said electronic interruption unit having semiconductor-based switching elements assuming a high-ohmic state for preventing the current flux, or a low-ohmic state for enabling the current flux in the low-voltage circuit;
a control unit connected to said differential current sensor unit, to said mechanical break contact unit and to said electronic interruption unit;
the circuit-breaker or said control unit configured, in an event of an overshoot of first differential current limiting values, or of first differential current-time limiting values, to initiate a prevention of the current flux in the low-voltage circuit by a high-ohmic state of said switching elements of said electronic interruption unit, with said break contacts in a closed state; and
further to the prevention of the current flux by the high-ohmic state of said switching elements of said electronic interruption unit, with said break contacts in the closed state, a check being executed for a presence of an overshoot of second differential current limiting values or of second differential current-time limiting values.

22. The circuit-breaker according to claim 21, wherein upon an absence of the overshoot of the second differential current limiting values or second differential current-time limiting values over a first time range being shorter than 200 ms, said electronic interruption unit executes a switchover to the low-ohmic state.

23. The circuit-breaker according to claim 21, wherein upon an event of the overshoot of the second differential current limiting values or second differential current-time limiting values being in force for a first time period being shorter than 300 ms, said break contacts are opened.

24. The circuit-breaker according to claim 22, which further comprises a communication or input unit, upon an absence of an overshoot of the second differential current limiting values or second differential current-time limiting values over a second time range being shorter than 5 s, said electronic interruption unit only executing a switchover to the low-ohmic state in an event of an acknowledgement being executed by said communication or input unit.

25. The circuit-breaker according to claim 21, wherein said mechanical break contact unit is associated with said load-side terminals.

26. The circuit-breaker according to claim 21, wherein the check for the presence of the overshoot of the second differential current limiting values or second differential current-time limiting values is executed by an assumption of a low-ohmic state by at least one or by two or by all of said switching elements of said electronic interruption unit, for a first switch-on time being shorter than 20 ms.

27. The circuit-breaker according to claim 21, wherein the check for the presence of the overshoot of the second differential current limiting values or second differential current-time limiting values is executed by an assumption of a low-ohmic state by at least one or by two or by all of said switching elements of said electronic interruption unit, at a quantitative instantaneous voltage value being lower than a first voltage threshold value.

28. The circuit-breaker according to claim 27, wherein said switching elements are restored to a high-ohmic state at a quantitative instantaneous voltage value being higher than a second voltage threshold value.

29. The circuit-breaker according to claim 21, wherein the check for the presence of the overshoot of the second differential current limiting values or second differential current-time limiting values is executed by an application of an auxiliary voltage being lower than a first voltage limit.

30. The circuit-breaker according to claim 21, wherein the check for the presence of the overshoot of the second differential current limiting values or second differential current-time limiting values is executed at a first time interval being 1, 3, 5, 10, 15 or 30 seconds or 1, 5, 10 or 15 minutes, and the check at the first time interval is executed further to an expiry of a first time period.

31. The circuit-breaker according to claim 30, wherein in an event of a continuing presence of the overshoot of the second differential current limiting values or second differential current-time limiting values, further to an expiry of a first time limit, said mechanical break contact unit executes a switchover to an open state of said break contacts, and said first time limit is 15 minutes to 48 hours.

32. A method for operating a circuit-breaker for protecting a low-voltage electric circuit, the method comprising:
providing grid-side and load-side terminals for conductors of the low-voltage circuit;
providing a mechanical break contact unit having break contacts assuming a closed state for enabling a current flux in the low-voltage circuit, or an open state for preventing the current flux by a galvanic interruption of the low-voltage circuit;
providing an electronic interruption unit having a circuit side connected in series with the mechanical break contact unit, the electronic interruption unit having semiconductor-based switching elements assuming a high-ohmic state for preventing the current flux, or a low-ohmic state for enabling the current flux in the low-voltage circuit;
ascertaining a magnitude of a differential current on the conductors of the low-voltage circuit, in an event of an overshoot of first differential current limiting values or of first differential current-time limiting values, initiating a prevention of the current flux in the low-voltage circuit by a high-ohmic state of the switching elements of the electronic interruption unit, with the break contacts in a closed state; and
further to the prevention of the current flux by the high-ohmic state of the switching elements of the electronic interruption unit, with the break contacts in the closed state, executing a check for a presence of an overshoot of second differential current limiting values or of second differential current-time limiting values.

33. The method according to claim 32, which further comprises upon an absence of the overshoot of the second differential current limiting values or second differential current-time limiting values over a first time range, using the electronic interruption unit to execute a switchover to the low-ohmic state.

34. The method according to claim 32, which further comprises in an event of the overshoot of the second differential current limiting values or the second differential current-time limiting values being in force for a first time period being shorter than 300 ms, the break contacts being opened.

35. The method according to claim 33, which further comprises upon an absence of the overshoot of the second differential current limiting values or the second differential current-time limiting values over a second time range, the electronic interruption unit only executing a switchover to the low-ohmic state upon an acknowledgement being executed.

36. The method according to claim 32, which further comprises executing the check for the presence of the overshoot of the second differential current limiting values or second differential current-time limiting values by an assumption of a low-ohmic state by at least one or by two or by all of the switching elements of the electronic interruption unit, for a first switch-on time being shorter than 20 ms.

37. The method according to claim 32, which further comprises executing the check for the presence of the overshoot of the second differential current limiting values or second differential current-time limiting values by an assumption of a low-ohmic state by at least one or by two or by all of the switching elements of the electronic interruption unit at a quantitative instantaneous voltage value being lower than a first voltage threshold value.

38. A non-transitory computer program product, comprising commands which, upon execution of the program by a microcontroller, initiate the execution by the microcontroller, further to a prevention of a current flux by a high-ohmic state of switching elements of the electronic interruption unit, with the contacts in a closed state, of the check for the presence of the overshoot of the second differential current limiting values or second differential current-time limiting values, according to claim 21.

39. A non-transitory computer-readable storage medium, on which the computer program product according to claim 38 is saved.

40. A data carrier signal, being transmitted by the computer program product according to claim 38.
